(19) United States
(12) Patent Application Publication
(10) Pub. No.: US 2024/0177067 A1
(43) Pub. Date: May 30, 2024

(54) SYSTEM AND METHOD FOR MANAGING DEPLOYMENT OF RELATED INFERENCE MODELS

(71) Applicant: Dell Products L.P., Round Rock, TX (US)

(72) Inventors: OFIR EZRIELEV, Beer Sheva (IL); JEHUDA SHEMER, Kfar Saba (IL); TOMER KUSHNIR, Omer (IL)

(21) Appl. No.: 18/060,089

(22) Filed: Nov. 30, 2022

(51) Int. Cl. G06N 20/20

(52) U.S. Cl. CPC G06N 20/20

(57) ABSTRACT

Methods and systems for managing inference models hosted by data processing systems are disclosed. To manage the inference models, inference models that may share computations with other inference models may be preferentially selected for deployment. Additionally, the inference models may be divided into portions to distribute the computation load across more data processing systems. The location of deployment of the portions of the inference models may be preferentially selected based on the locations of data sources and inference consumers.

### FIELD

Embodiments disclosed herein relate generally to inference generation. More particularly, embodiments disclosed herein relate to systems and methods to manage deployment of inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements

FIG. 1 shows a block diagram illustrating a system in accordance with an embodiment.

FIG. 2A shows a block diagram illustrating an inference model manager and multiple data processing systems over time in accordance with an embodiment.

FIG. 2B shows a block diagram illustrating multiple data processing systems over time in accordance with an embodiment.

FIG. 2C shows a topology diagram illustrating a potential inference model deployment in accordance with an embodiment.

FIG. 3 shows a flow diagram illustrating a method of managing inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “an embodiment” or “an embodiment” means that a particular feature, structure, or characteristic described in conjunction with the embodiment can be included in at least an embodiment. The appearances of the phrases “in an embodiment” and “an embodiment” in various places in the specification do not necessarily all refer to the same embodiment.

In general, embodiments disclosed herein relate to methods and systems for managing inference models hosted by data processing systems. The inference models may generate inferences used to provide computer implemented services.

To manage the inference models, a deployment plan that reduces resource expenditures for inference generation may be obtained and implemented. The deployment plan may preferentially deploy inference models that may share computations with other inference models thereby allowing a single set of shared computations to be performed during inference generation.

The deployment plan may also preferentially deploy portions of inference models that ingest data proximate to the sources of the data, and preferentially deploy other portions of inference models that output inferences proximate to consumers of the inferences. By doing so, the computing resource cost for generating and distributing inference may be reduced.

To obtain the deployment plan, the goals of downstream consumers may be used to identify the types of inference models to deploy. Once the inference model types are identified, the locations of data sources and inference consumers may be used to identify where certain portions of the inference models will be deployed.

The manifest of the inference models, and portions thereof, that will be deployed may be established by ascertaining whether any inference models may share portions with other to-be-deployed inference models and/or existing instances of deployed inference models. Any inference model portions that may be reused or used by multiple inference models may be preferentially selected for inclusion in the deployment plan.

Once obtained, the deployment plan may be used to guide subsequent deployment of inference models to the data processing systems. Once deployed, the inference models may generate inferences desired by inference model consumers.

By doing so, the computing resources expended for inference generation may be reduced. Thus, embodiments disclosed herein may provide improved computing devices that are better able to marshal limited computing resources for inference generation. Accordingly, embodiments disclosed herein may address, among others, the technical challenge of limited computing resources for providing computer implemented services. The disclosed embodiments may address this problem by improving the efficiency of use of computing resources for inference generation.

In an embodiment, a method of managing inference models hosted by data processing systems is provided. The method may include obtaining first location data for sources of data usable to obtain inferences; obtaining second location data for consumers of the inferences; obtain a first inference model based on a first goal of the consumers for deployment to the data processing systems; obtain a second inference model based on a second goal of the consumers for deployment to the data processing systems, the second inference model sharing at least one hidden layer with the first inference model; obtaining a deployment plan for the first inference model and the second inference model, the deployment plan specifying: a first deployment location for a shared portion of the first inference model and the second inference model based on the first location data, second deployment locations for independent portions of the first inference model and the second inference model based on the second location data, and that the shared portion is to distribute a partial processing result to both of the independent portions; deploying the first inference model and the second inference model to the data processing systems based on the deployment plan; and providing inferences to the consumers using the deployed first inference model, the deployed second inference model, and the sources of data.

The second inference model may include one of the independent portions, the one of the independent portions being obtained via transfer learning with the first inference model.

Obtaining the deployment plan may include identifying a first data processing system of the data processing systems nearest to a source of the sources of data; identifying a second data processing system of the data processing systems nearest to a consumer of the consumers that provided the first goal; identifying a third data processing system of the data processing systems nearest to a second consumer of the consumers that provided the second goal; selecting the first data processing system for deployment of a shared input layer of the first inference model and the second inference model; selecting the second data processing system for deployment of a first output layer of a first of the independent portions; and selecting the third data processing system for deployment of a second output layer of a second of the independent portions.

Providing the inferences may include generating, using the shared input layer and the shared hidden layer, a partial processing result; providing the partial processing result to both of the independent portions; generating a first inference by the first of the independent portions, the first inference being responsive to the first goal; and generating a second inference by the second of the independent portions, the second inference being responsive to the second goal; and.

Obtaining the deployment plan may include making an identification that an instance of the first inference model is hosted by the data processing systems; based on the identification: making a determination regarding whether an input layer of the instance of the first inference model and an output layer of the instance of the first inference model are within predetermined distances of locations specified by the first location data and the second location data; and in an instance of the determination where the input layer of the instance of the first inference model and an output layer of the instance of the first inference model are within the predetermined distances: establishing the instance of the first inference model as being part of the deployment plan; and establishing a new instance of the second inference model that depends on operation of the instance of the first inference model.

Obtaining the first location data may include identifying latency of communication between each of the data processing systems and the sources of the data; ranking the data processing systems based on the latency to obtain a ranking; and obtaining the first location data based on the ranking.

The first inference model and the second inference model comprise machine learning models, and the shared portion comprises an input layer and a hidden layer.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

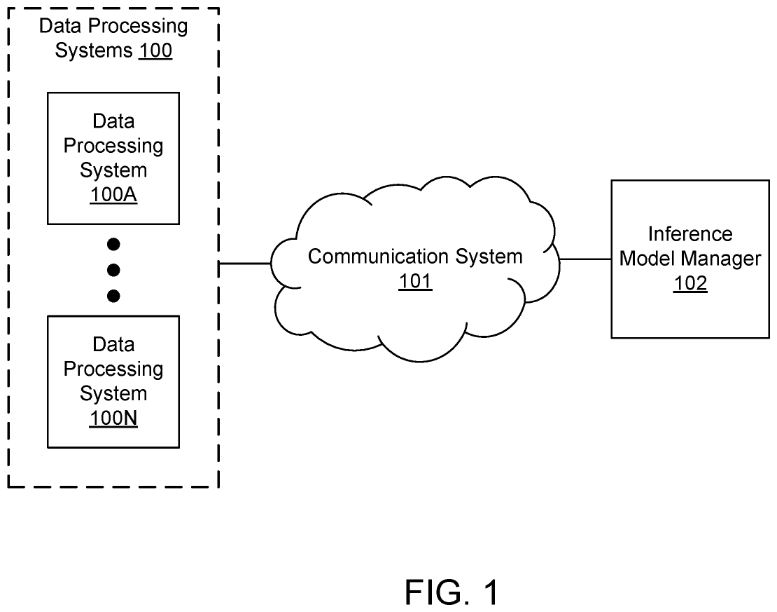

Turning to FIG. 1, a block diagram illustrating a system in accordance with an embodiment is shown. The system shown in FIG. 1 may provide computer-implemented services that may utilize inferences generated by executing inference models hosted by data processing systems throughout a distributed environment.

The system may include inference model manager 102. Inference model manager 102 may provide all, or a portion, of the computer-implemented services. For example, inference model manager 102 may provide computer-implemented services to users of inference model manager 102 and/or other computing devices operably connected to inference model manager 102. The computer-implemented services may include any type and quantity of services which may utilize, at least in part, inferences generated by the inference models hosted by the data processing systems throughout the distributed environment.

To facilitate execution of the inference models, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the execution of the inference models.

For example, all, or a portion, of data processing systems 100 may provide computer-implemented services to users and/or other computing devices operably connected to data processing systems 100. The computer-implemented services may include any type and quantity of services including, for example, generation of a partial or complete processing result using an inference model of the inference models. Different data processing systems may provide similar and/or different computer-implemented services.

To obtain inferences, data processing systems 100 may expend computing resources. If the expenditure of computing resources for obtaining inferences is too large, then data processing systems 100 may be unable to provide all of their services. Likewise, if there are a limited number of data processing systems 100, then there may be a limit in the rate at which the computations needed to obtain inferences may be performed.

In general, embodiments disclosed herein may provide methods, systems, and/or devices for managing deployment of inference models to data processing systems 100 to reduce computing resource use for inference generation. By reducing the computing resources expended for inference generation, data processing systems 100 may (i) generate more inferences per unit time (e.g., when limited in number thereby limiting the total number of inference models that may be hosted by data processing systems 100) and (ii) be able to provide other computer implemented services timelier.

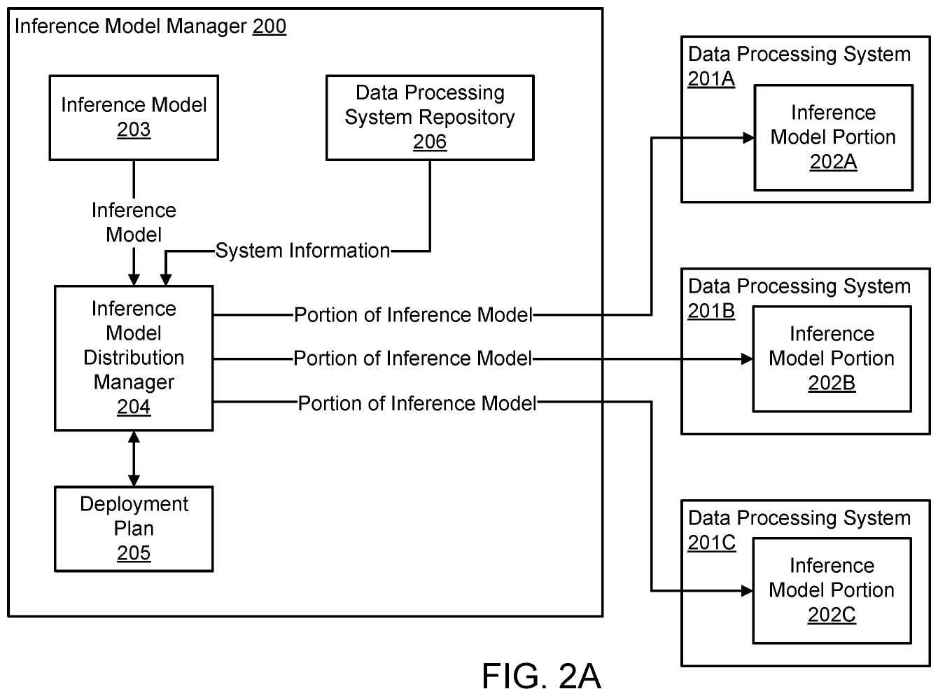

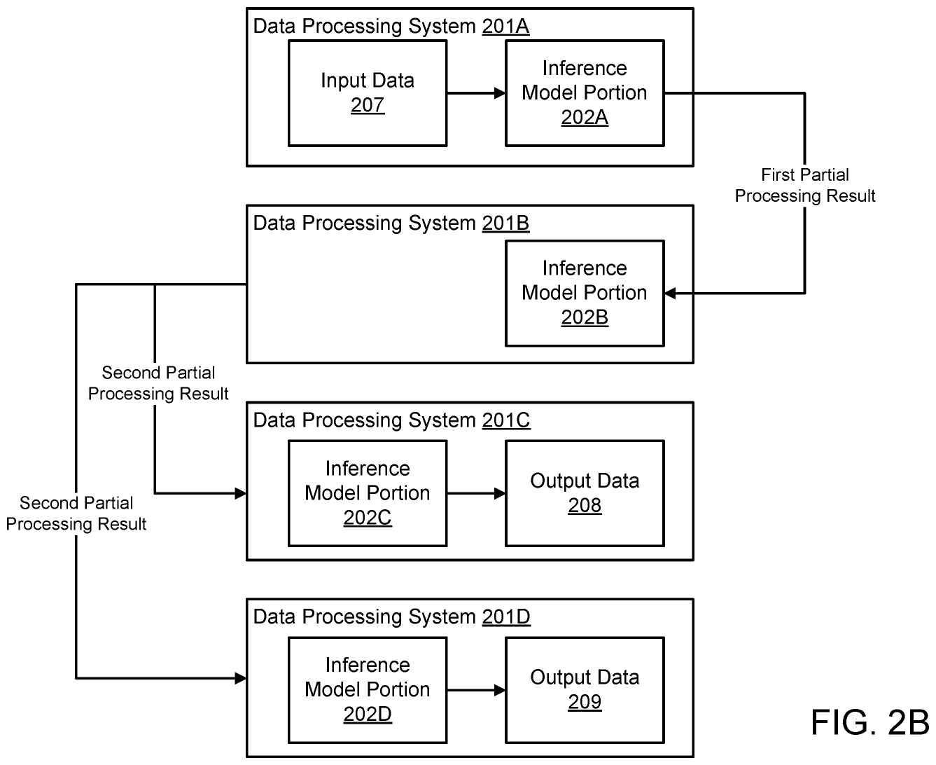

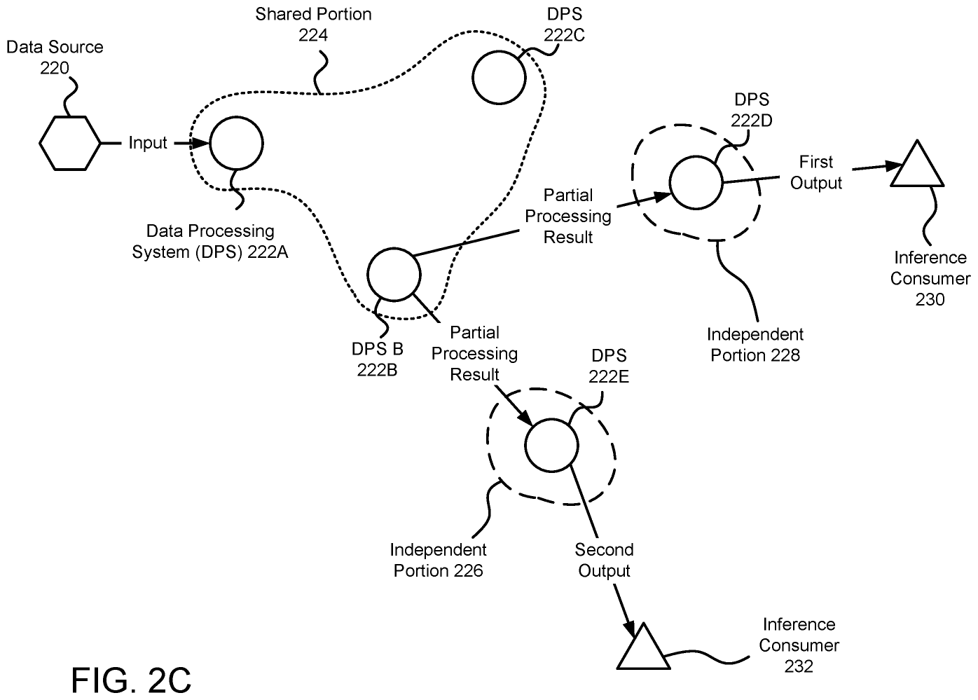

To reduce the computing resources used for inference generation, the system may preferentially select inference models that may share computations while generating inferences for deployment (e.g., over other inference models that do not share computations). For example, through transfer learning and/or other techniques a shared portion of an inference model may be used to generate multiple, different inferences. By sharing performance of some computations, the aggregate quantity of computing resources to obtain inferences may be reduced. Refer to FIG. 2B for additional details regarding shared portions of inference models.

To further reduce computing resources, the system may select locations (e.g., data processing systems) for where both shared and independent calculations will be performed to obtain inferences. Generally, locations near data sources may be selected for performance of shared calculations, and locations near consumers of inferences may be selected for performance of independent calculations. However, it will be appreciated that other factors may also be taken into account when selecting locations for performance of shared and independent computations such as, for example, bandwidth between locations where computations may be performed, workloads being performed at the locations and/or availability of computing resources in the locations, etc.

Once location preferences for inference models are identified, a deployment plan may be established. Due to limitations in available computing resources, the inference models may be divided into portions and distributed across multiple data processing systems. The deployment plan may specify, for example, numbers and types of portions of inference models (shared or independent) to be hosted by data processing systems 100. Refer to FIG. 2A for additional details regarding dividing of inference models into portions and distributing them across data processing systems.

The deployment plan may be used to deploy portions of inference models (e.g., shared computation and/or independent) to the data processing systems. The resulting deployment may preferentially deploy input layers near data sources and output layers near inference consumers. Refer to FIG. 2C for additional details regarding locations of portions of inference models.

By doing so, embodiments disclosed herein may provide a system that more efficiently marshals limited computing resources for inference generation. For example, edge computing devices, user devices, internet of things (IOT) devices, and/or other types of data processing systems 100 may have limited computing resources. By preferentially selecting shared computation model, and preferentially deploying portions of inference models near data sources and inference consumers, the computing resources needed to obtain inference may be reduced. Thus, embodiments disclosed herein may provide an improved data processing system that is more likely to be able to provide desired computer implemented services while also cooperatively generating inferences.

To provide the above noted functionality, the system of FIG. 1 may include inference model manager 102. Inference model manager 102 may (i) obtain information regarding locations of data sources and consumers of inferences, (ii) establish and deploy inference models in accordance with deployment plans based on the locations, and (iii) provide inferences to consumers using shared computations performed by the deployed inference models. By doing so, inference model manager 102 may manage inference models in a manner that reduces the computational cost for generating inferences.

Any of the inference models hosted by data processing systems 100 may be distributed. For example, any of the inference models may be implemented using trained neural networks. The trained neural network may include, for example, an input layer, any number of hidden layers, an output layer, and/or other layers. Some of the trained neural network may be derived from other trained neural network using transfer learning. For example, a portion (e.g., an input layer, some number of hidden layers) of a first trained neural network may be used as part of a second trained neural network. Consequently, execution of the portion of the first trained neural network may be used to generate a partial processing result usable by the first trained neural and the second trained neural network to each generate inferences. Thus, a single set of computations may be shared if these two neural network are selected for deployment.

For deployment, the trained neural networks may be divided into any number of portions and distributed across data processing systems 100. For example, the inference models may be distributed in this manner due to the limited computing resources available to each of data processing systems 100. The deployment plan may take into account this division and may provide for distributed execution of the inference models (e.g., may include information indicating where partial results are to be forwarded). Refer to FIGS. 2A-2B regarding generation of inferences using distributed inference models.

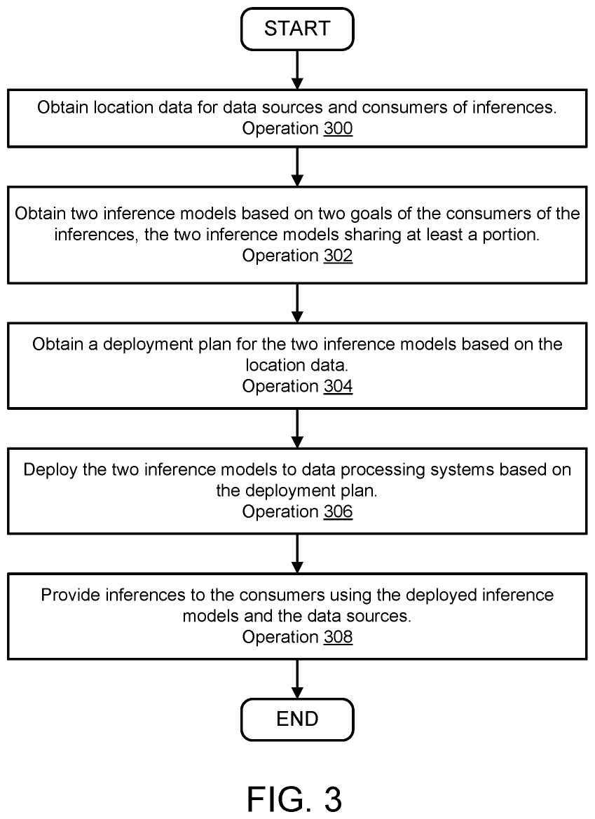

When performing its functionality, inference model manager 102 and/or data processing systems 100 may perform all, or a portion, of the methods and/or actions shown in FIG. 3.

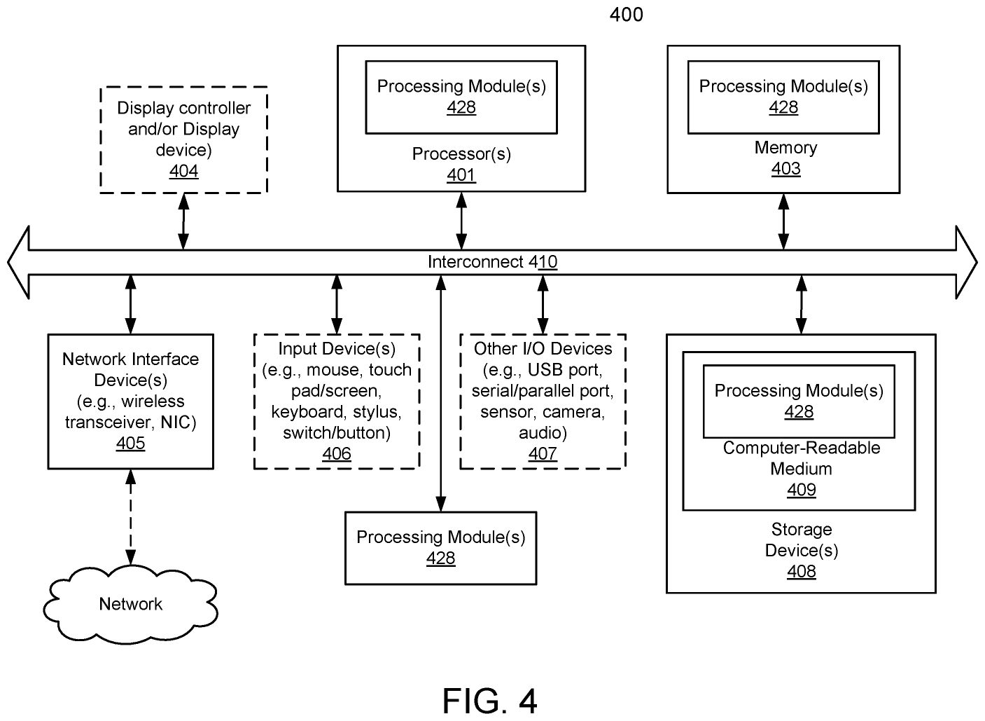

Data processing systems 100 and/or inference model manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100 and/or inference model manager 102 are implemented using an IoT device, which may include a computing device. The IoT device may operate in accordance with a communication model and/or management model known to inference model manager 102, other data processing systems, and/or other devices.

Any of the components illustrated in FIG. 1 may be operably connected to each other (and/or components not illustrated) with communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows and/or processes performed in a system in accordance with an embodiment are shown in FIGS. 2A-2C. Specifically, FIGS. 2A-2B illustrate data flows during deployment and execution of distributed inference models, and FIG. 2C illustrates a topology of a deployment.

Turning to FIG. 2A, a diagram of inference model manager 200 and data processing systems 201A-201C in accordance with an embodiment is shown. Inference model manager 200 may be similar to inference model manager 102, and data processing systems 201A-201C may be similar to any of data processing systems 100. In FIG. 2A, inference model manager 200 and data processing systems 201A-201C are connected to each other via a communication system (not shown). Communications between inference model manager 200 and data processing systems 201A-201C are illustrated using lines terminating in arrows.

As discussed above, inference model manager 200 may perform computer-implemented services by executing an inference model across multiple data processing systems that each individually have insufficient computing resources (e.g., storage space, processing bandwidth, memory space, etc.) to complete timely execution (e.g., in accordance with an expectation of an entity, such as a downstream consumer of an inference) of the inference model.

While described below with reference to a single inference model (e.g., inference model 203), the process may be repeated any number of times with any number of inference models without departing from embodiments disclosed herein. For example, as part of generating and implementing a deployment plan.

To execute an inference model across multiple data processing systems, inference model manager 200 may obtain inference model portions and may distribute the inference model portions to data processing systems 201A-201C. The inference model portions may be based on: (i) the computing resource availability of data processing systems 201A-201C and (ii) communication bandwidth availability between the data processing systems. By doing so, inference model manager 200 may distribute the computational overhead and bandwidth consumption associated with hosting and operating the inference model across multiple data processing systems. While described and illustrated with respect to distributing inference model portions, it will be appreciated that instructions for which inference models portions to host may be distributed to the data processing systems (or other entities) and the data processing systems may take responsibility for obtaining and hosting the inference models portions without departing from embodiments disclosed herein.

To obtain inference model portions, inference model manager 200 may host inference model distribution manager 204. Inference model distribution manager 204 may (i) obtain an inference model and/or deployment plan 205, (ii) identify characteristics (e.g., available computing resources/communication bandwidth) of data processing systems to which the inference model may be deployed, (iii) obtain inference model portions based on the characteristics of the data processing systems and characteristics of the inference model, (iv) distribute the inference model portions to the data processing systems, (v) initiate execution of the inference model using the inference model portions distributed to the data processing systems and/or (vi) manage the execution of the inference model based on deployment plan 205.

To facilitate model deployment, inference model manager 200 may obtain inference model 203. Inference model manager 200 may obtain characteristics of inference model 203.

The characteristics of inference model 203 may include, for example, a quantity of layers of a neural network inference model and a quantity of relationships between the layers of the neural network inference model. The characteristics of inference model 203 may also include the quantity of computing resources required to host and operate inference model 203. The characteristics of inference model 203 may include other characteristics based on other types of inference models without departing from embodiments disclosed herein.

Each portion of inference model 203 may be distributed to one data processing system throughout a distributed environment. Therefore, prior to determining the portions of inference model 203, inference model distribution manager 204 may obtain system information from data processing system repository 206. System information may include a quantity of the data processing systems, a quantity of available memory of each data processing system of the data processing systems, a quantity of available storage of each data processing system of the data processing systems, a quantity of available communication bandwidth between each data processing system of the data processing systems and other data processing systems of the data processing systems, and/or a quantity of available processing resources of each data processing system of the data processing systems.

Using the system information, inference model distribution manager 204 may obtain a first portion of the inference model (e.g., inference model portion 202A) based on the system information (e.g., the available computing resources) associated with data processing system 201A and based on data dependencies of the inference model (e.g., weights) so that inference model portion 202A reduces the necessary communications between inference model portion 202A and other portions of the inference model (e.g., when compared to other type of division of the inference model). Inference model distribution manager 204 may repeat the previously described process for inference model portion 202B and inference model portion 202C.

Prior to distributing inference model portions 202A-202C, inference model distribution manager 204 may obtain deployment plan 205. Deployment plan 205 may indicate the distribution of the inference model portions across data processing systems. The deployment plan may be obtained, for example, by using an objective function or other method to ascertain locations to which inference model portions are to be deployed to meet objectives. These objectives may include, for example, reducing communication bandwidth, reducing latency due to communications, improving reliability of data transmission between data processing systems, elimination or reduction of bottlenecks (e.g., a data processing system that host multiple portions of inference models, which may result in a failure of multiple inference models if the single data processing system fails), re-use of existing instances of deployed inference models (e.g., such as inference models that may have been used to derive new inference models, and some of the computation performed while executing the inference model may be used by the derived inference models), and/or other types of goals.

Inference model manager 200 may distribute inference model portion 202A to data processing system 201A, inference model portion 202B to data processing system 201B, and inference model portion 202C to data processing system 201C, in accordance with deployment plan 205. While shown in FIG. 2A as distributing three portions of the inference model to three data processing systems, the inference model may be partitioned into any number of portions and distributed to any number of data processing systems throughout a distributed environment.

Additionally, while illustrated with respect to a completely new deployment, if an existing inference model had already been deployed that includes a shared portion with a to-be-deployed inference model, the shared portion may be used to perform some of the computations necessary to be performed for executing of the to-be-deployed inference model. Thus, in such a scenario, only independent portions of the to-be-deployed inference model may be deployed, and the existing inference model may be configured to also send the computation results of the shared portion to the newly deployed independent portion of the to-be-deployed inference model as well.

Further, while not shown in FIG. 2A, inference model distribution manager 204 may, in accordance with deployment plan 205, distribute (i) redundant copies of the inference model portions to various data processing systems, and (ii) copies of other inference model portions to comply with various modes of operation specified by deployment plan 205.

Once deployed, inference model portions (e.g., 202A-202C) may execute thereby generating inferences. The inferences may be used to drive downstream computer implemented services such as, for example, database service, communication services, logistics services, and/or any other types of services that may be implemented using inferences.

In an embodiment, inference model distribution manager 204 is implemented using a processor adapted to execute computing code stored on a persistent storage that when executed by the processor performs the functionality of inference model distribution manager 204 discussed throughout this application. The processor may be a hardware processor including circuitry such as, for example, a central processing unit, a processing core, or a microcontroller. The processor may be other types of hardware devices for processing information without departing from embodiments disclosed herein.

Turning to FIG. 2B, a diagram illustrating data flow during execution of inference models portions (e.g., 202A-202D) in accordance with an embodiment is shown. Inference model portions 202A-202C may be part of a first inference model, and inference model portions 202A, 202B, and 202D may be part of a second inference model. To reduce the computing resources used for execution of both inference models, only a single copy of each of the inference model portions may be deployed to data processing systems 201A-201D.

While executing, data processing system 201A may obtain input data 207. Input data 207 may include any data of interest (or that may otherwise be used as a basis for an inference) to a downstream consumer of the inferences. For example, input data 207 may include data indicating the operability and/or specifications of a product on an assembly line.

Input data 207 may be fed into inference model portion 202A to obtain a first partial processing result. The first partial processing result may include values and/or parameters associated with a portion of the first inference model. The first partial processing result may be transmitted (e.g., via a wireless communication system) to data processing system 201B. Data processing system 201B may feed the first partial processing result into inference model portion 202B to obtain a second partial processing result. The second partial processing result may include values and/or parameters associated with a second portion of the first inference model. The second partial processing result may be transmitted to both data processing system 201C and data processing system 201D. Data processing system 201C may feed the second partial processing result into inference model portion 202C to obtain output data 208. Output data 208 may include inferences collectively generated by the portions of the first inference model distributed across data processing systems 201A-201C.

In contrast, data processing system 201D may feed the second partial processing result into inference model portion 202D to obtain output data 209. Output data 209 may include inferences collectively generated by the portions of the second inference model distributed across data processing systems 201A, 202B, and 202D. Consequently, two inferences may be generated using the shared computations performed by data processing system 201A and data processing system 201B.

Output data 208 and output data 209 may be utilized by a downstream consumer (or multiple different downstream consumers) of the data to perform a task, make a decision, and/or perform any other action set that may rely on the inferences generated by the two inference models. For example, output data 208 may include a quality control determination regarding a product manufactured in an industrial environment. Output data 208 may indicate whether the product meets the quality control standards and should be retained or does not meet the quality control standards and should be discarded. In this example, output data 208 may be used by a robotic arm to decide whether to place the product in a “retain” area or a “discard” area.

Similarly, output data 209 may indicate a type of the finished product. Output data 209, in this example, may be used by the robotic arm to decide whether to place each newly finished product into different bins.

While shown in FIG. 2B as including four data processing systems, a system may include any number of data processing systems to collectively execute any number of inference model, and any number of which may share various portions (e.g., in this example inference model portions 202A-202B). Additionally, as noted above, redundant copies of the inference model hosted by multiple data processing systems may each be maintained so that termination of any portion of the inference model may not impair the continued operation of the inference model.

While described above as feeding input data 207 into data processing system 201A and obtaining output data 208 and output data 209 via data processing system 201C and 201D, other data processing systems may utilize input data and/or obtain output data without departing from embodiments disclosed herein. For example, data processing system 201B-201D may obtain input data (not shown). In another example, data processing system 201A and/or data processing system 201B may generate output data (not shown). A downstream consumer may be configured to utilize output data obtained from data processing system 201A and/or data processing system 201B to perform a task, make a decision, and/or perform an action set.

By executing an inference model across multiple data processing systems, computing resource expenditure throughout the distributed environment may be reduced. In addition, by managing execution of the inference model, the functionality and/or connectivity of the data processing systems may be adapted over time to remain in compliance with the needs of a downstream consumer.

Turning to FIG. 2C, a topology of an example deployment of two inference models in accordance with an embodiment is shown. In FIG. 2C, data processing systems (e.g., 222A-222E) which may host inference model portions are illustrated using circles, inference consumers (e.g., 230-232) are illustrated using triangles, and data sources (e.g., 220) which may provide data upon which inference may be based are illustrated using a hexagon. Generally, the example topology indicates that data source 220 is positioned away from inference consumers 230-232.

Now, consider a scenario where inference consumers 230-232 desire access to different inferences. However, the inferences may be obtained using two inference models that both use shared portion 224 (each may also utilize different independent portions 226, 228). For example, one of the inference models may have been derived from the other, and may successfully operate using a partial processing result obtained from shared portion 224 of the two inference models. Shared portion 224 may include, for example, an input layer and some number of hidden layers. In contrast, each of the independent portions may include any number of hidden layers (e.g., 0, 1, 2, etc.) and an output layer. The independent portions may each have been trained to output different types of inferences.

In addition to needing to ascertain how to divide the inference models across data processing systems due to resource limitations, as described with respect to FIGS. 2A-2B, the location for deployment of each of the inference model portions may also need to be determined. To determine where to deploy both shared portion 224 of the inference models and independent portions 226, 228 of the inference models, the locations of data source 220 and inference consumers 230-232 may be taken into account.

For example, to reduce bandwidth used to obtain input data, shared portion 224 may be preferentially deployed to the data processing systems (e.g., 222A-222C) proximate to data source 220. Consequently, to operate, data source 220 may provide input data to input layers hosted by these data processing systems. While not shown in FIG. 2C, partial processing results may be internally distributed among the portions of shared portion 224 based on how shared portion 224 is distributed across data processing systems 222A-222C.

In contrast, independent portions 226, 228, which may generate output in the form of inferences, may be preferentially placed proximate to the inference consumers that consume the inferences generated by the respective inference models. For example, if inference consumer 230 desires access to a first type of inference and independent portion 228 provide inferences of the first type of inference, then independent portion 228 may be preferentially deployed to data processing system 222D. Similarly, independent 226, which may generate a second type of inference, may be preferentially deployed to data processing system 222E if inference consumer 232 desires access to inference of the second type of inference. In this manner, data processing systems 222D, 222E may minimize the latency and consumed bandwidth for providing inferences to the respective inference consumers.

Because both independent portions 226, 228 may use partial processing results from shared portion 224, the same partial processing result may be transmitted to data processing systems 222D, 222E. Consequently, both independent portions may be able to generate two different inferences.

While described with respect to selection of deployment locations preferentially, it will be appreciated that an objective function and optimization process may be performed to select where to deploy each of the portions of the inference models. For example, the objective function may be crafted to (i) reduce communication bandwidth/latency, (ii) reduce computing resource expenditures, and/or (iii) direct placement decisions to meet other goals. The optimization process may be performed via any optimization method such as, for example, the gradient descent optimization method, genetic algorithm optimization, etc.

As discussed above, the components of FIG. 1 may perform various methods to manage inference models to limit computing resource expenditures for inference generation. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing inference models hosted by data processing systems in accordance with an embodiment is shown. The method may be performed, for example, by data processing systems (e.g., 100), an inference model manager (e.g., 102), and/or other components.

At operation 300, location data for data sources and consumers of inferences may be obtained. The location may be obtained by (i) obtaining it from the consumers and data sources (e.g., via self-reporting), (ii) obtaining it from other systems (e.g., geographic information systems), (iii) generating it (e.g., by measuring the locations of the consumers/data sources), and/or (iv) via other methods.

The location data my indicate the locations of the data sources and the consumers of the inferences. Similar location information for data processing systems that may host inference models may also be obtained.

At operation 302, two inference models based on two goals of the consumers of the inferences are obtained. The two inference models may be obtained by identifying the types of the inference models that may generate inferences of types that meet the two goals of the consumers.

For example, different consumers may have different goals with respect to the types of inference that they may wish to have access to in a system. The goals may directly (e.g., by specifying) or indirectly (e.g., may be used to perform a lookup) indicate the types of inference models that may need to be present for the inferences to be generated and provided to the consumers.

The two inference models may be preferentially selected so that the two inference models are capable of sharing a portion. For example, one of the two inference models may be derived from the other inference model. Consequently, the two inference models may be deployed by instantiating one instance of the shared portion common to both inference models, and instantiating independent portions that vary between the inference models.

At operation 304, a deployment plan for the two inference models is obtained based on the location data. The deployment plan may be obtained by a generating a data structure indicating where each portion of each of the two inference models will be deployed.

To identify where to deploy the shared portion, the data processing systems may be ranked with respect to their distances (e.g., physical or communication distance) to the data sources. The data processing systems ranked nearest to the data sources may be preferentially selected as the location to which to deploy the portions of the shared portion of the inference models.

To identify where to deploy the independent portions, the data processing systems may be ranked with respect to their distances (e.g., physical or communication distance) to the inference consumers. The data processing systems ranked nearest to the respective inference consumers may be preferentially selected as the location to which to deploy the portions of the respective independent portions of the two inference models.

In addition to consider where to deploy the inference model portions, existing instances of inference models may also be taken into account. For example, if either of the two inference models are derived from other inference models, the existing instances of inference models may be checked to ascertain whether any shared portions of the two inference models are already deployed. If an existing instance of the inference model includes a shared portion of either of the two inference models, the deployment plan may be modified to preferentially utilize that shared portion rather than deploying a new shared portion. Thus, in scenarios in which shared portions are already deployed, the deployment plan may be updated to only indicate future deployment the corresponding independent portions of the two inference models, and that the data processing systems hosting the existing instances of the shared portions are to be updated to further distribute processing results from the shared portions to the other data processing systems that will host the independent portions of the two inference models.

However, in some scenarios, the existing shared portions may be deployed to data processing systems that may be problematic. An objective function or other metric may be used to decide whether the existing shared portions should be used or new shared portions should be deployed. For example, the objective function may take into account the reliability of operation of the data processing systems hosting the existing shared model, and may indicate deployment of a new instance of the shared portion if the reliability of the data processing system is insufficient (e.g., for the purposes of the consumers of the inferences, which may directly specify thresholds or other basis for comparison).

At operation 306, the two inference models are deployed to the data processing systems based on the deployment plan. The two inference models may be deployed by (i) instantiating an instance of the shared portion to a portion of the data processing systems as specified by the deployment plan and (ii) instantiating instances of the independent portions to other portions of the data processing systems as specified by the deployment plan. The shared portion, and/or host data processing systems, may be programmed to direct processing results generated by the shared portion to both of the independent portions hosted by the other data processing systems.

At operation 308, inference are provided to the consumers using the deployed inference models and the data sources. The inferences may be provided by initiating execution of the deployed two inference models.

The method may end following operation 308.

While described with respect to two inference models, it will be appreciated that any number of inference models may be deployed using the method illustrated in FIG. 3.

Using the method illustrated in FIG. 3, a system in accordance with an embodiment may marshal limited resources to provide computer implemented services while also providing inferences. The system may do so through preferential deployment of shared inference model portions at locations where communication bandwidth for operation of the inference models may be conserved.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In an embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in an embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing inference models hosted by data processing systems, the method comprising:
obtaining first location data for sources of data usable to obtain inferences;
obtaining second location data for consumers of the inferences;
obtain a first inference model based on a first goal of the consumers for deployment to the data processing systems;
obtain a second inference model based on a second goal of the consumers for deployment to the data processing systems, the second inference model sharing at least one hidden layer with the first inference model;
obtaining a deployment plan for the first inference model and the second inference model, the deployment plan specifying:
a first deployment location for a shared portion of the first inference model and the second inference model based on the first location data,
second deployment locations for independent portions of the first inference model and the second inference model based on the second location data, and
that the shared portion is to distribute a partial processing result to both of the independent portions;
deploying the first inference model and the second inference model to the data processing systems based on the deployment plan; and
providing inferences to the consumers using the deployed first inference model, the deployed second inference model, and the sources of data.

2. The method of claim 1, wherein the second inference model comprises one of the independent portions, the one of the independent portions being obtained via transfer learning with the first inference model.

3. The method of claim 2, wherein obtaining the deployment plan comprises:
identifying a first data processing system of the data processing systems nearest to a source of the sources of data;
identifying a second data processing system of the data processing systems nearest to a consumer of the consumers that provided the first goal;
identifying a third data processing system of the data processing systems nearest to a second consumer of the consumers that provided the second goal;
selecting the first data processing system for deployment of a shared input layer of the first inference model and the second inference model;
selecting the second data processing system for deployment of a first output layer of a first of the independent portions; and
selecting the third data processing system for deployment of a second output layer of a second of the independent portions.

4. The method of claim 3, wherein providing the inferences comprises:
generating, using the shared input layer and the shared hidden layer, a partial processing result;
providing the partial processing result to both of the independent portions;
generating a first inference by the first of the independent portions, the first inference being responsive to the first goal; and
generating a second inference by the second of the independent portions, the second inference being responsive to the second goal; and.

5. The method of claim 2, wherein obtaining the deployment plan comprises:
making an identification that an instance of the first inference model is hosted by the data processing systems;
based on the identification:
making a determination regarding whether an input layer of the instance of the first inference model and an output layer of the instance of the first inference model are within predetermined distances of locations specified by the first location data and the second location data; and
in an instance of the determination where the input layer of the instance of the first inference model and an output layer of the instance of the first inference model are within the predetermined distances:
establishing the instance of the first inference model as being part of the deployment plan; and
establishing a new instance of the second inference model that depends on operation of the instance of the first inference model.

6. The method of claim 1, wherein obtaining the first location data comprises:
identifying latency of communication between each of the data processing systems and the sources of the data;
ranking the data processing systems based on the latency to obtain a ranking; and
obtaining the first location data based on the ranking.

7. The method of claim 1, wherein the first inference model and the second inference model comprise machine learning models, and the shared portion comprises an input layer and a hidden layer.

8. A non-transitory machine-readable medium having instructions stored therein, which when executed by a processor, cause the processor to perform operations for managing inference models hosted by data processing systems, the operations comprising:
obtaining first location data for sources of data usable to obtain inferences;
obtaining second location data for consumers of the inferences;
obtain a first inference model based on a first goal of the consumers for deployment to the data processing systems;
obtain a second inference model based on a second goal of the consumers for deployment to the data processing systems, the second inference model sharing at least one hidden layer with the first inference model;
obtaining a deployment plan for the first inference model and the second inference model, the deployment plan specifying:
a first deployment location for a shared portion of the first inference model and the second inference model based on the first location data,
second deployment locations for independent portions of the first inference model and the second inference model based on the second location data, and
that the shared portion is to distribute a partial processing result to both of the independent portions;
deploying the first inference model and the second inference model to the data processing systems based on the deployment plan; and
providing inferences to the consumers using the deployed first inference model, the deployed second inference model, and the sources of data.

9. The non-transitory machine-readable medium of claim 8, wherein the second inference model comprises one of the independent portions, the one of the independent portions being obtained via transfer learning with the first inference model.

10. The non-transitory machine-readable medium of claim 9, wherein obtaining the deployment plan comprises:
identifying a first data processing system of the data processing systems nearest to a source of the sources of data;
identifying a second data processing system of the data processing systems nearest to a consumer of the consumers that provided the first goal;
identifying a third data processing system of the data processing systems nearest to a second consumer of the consumers that provided the second goal;
selecting the first data processing system for deployment of a shared input layer of the first inference model and the second inference model;
selecting the second data processing system for deployment of a first output layer of a first of the independent portions; and
selecting the third data processing system for deployment of a second output layer of a second of the independent portions.

11. The non-transitory machine-readable medium of claim 10, wherein providing the inferences comprises:
generating, using the shared input layer and the shared hidden layer, a partial processing result;
providing the partial processing result to both of the independent portions;
generating a first inference by the first of the independent portions, the first inference being responsive to the first goal; and
generating a second inference by the second of the independent portions, the second inference being responsive to the second goal; and.

12. The non-transitory machine-readable medium of claim 9, wherein obtaining the deployment plan comprises:
making an identification that an instance of the first inference model is hosted by the data processing systems;
based on the identification:
making a determination regarding whether an input layer of the instance of the first inference model and an output layer of the instance of the first inference model are within predetermined distances of locations specified by the first location data and the second location data; and
in an instance of the determination where the input layer of the instance of the first inference model and an output layer of the instance of the first inference model are within the predetermined distances:
establishing the instance of the first inference model as being part of the deployment plan; and
establishing a new instance of the second inference model that depends on operation of the instance of the first inference model.

13. The non-transitory machine-readable medium of claim 8, wherein obtaining the first location data comprises:
identifying latency of communication between each of the data processing systems and the sources of the data;
ranking the data processing systems based on the latency to obtain a ranking; and
obtaining the first location data based on the ranking.

14. The non-transitory machine-readable medium of claim 8, wherein the first inference model and the second inference model comprise machine learning models, and the shared portion comprises an input layer and a hidden layer.

15. A data processing system, comprising:
a processor; and
a memory coupled to the processor to store instructions, which when executed by the processor, cause the processor to perform operations for managing a distribution of inference models hosted by data processing systems, the operations comprising:
obtaining first location data for sources of data usable to obtain inferences;
obtaining second location data for consumers of the inferences;
obtain a first inference model based on a first goal of the consumers for deployment to the data processing systems;
obtain a second inference model based on a second goal of the consumers for deployment to the data processing systems, the second inference model sharing at least one hidden layer with the first inference model;
obtaining a deployment plan for the first inference model and the second inference model, the deployment plan specifying:
a first deployment location for a shared portion of the first inference model and the second inference model based on the first location data,
second deployment locations for independent portions of the first inference model and the second inference model based on the second location data, and
that the shared portion is to distribute a partial processing result to both of the independent portions;
deploying the first inference model and the second inference model to the data processing systems based on the deployment plan; and
providing inferences to the consumers using the deployed first inference model, the deployed second inference model, and the sources of data.

16. The data processing system of claim 15, wherein the second inference model comprises one of the independent portions, the one of the independent portions being obtained via transfer learning with the first inference model.

17. The data processing system of claim 16, wherein obtaining the deployment plan comprises:
identifying a first data processing system of the data processing systems nearest to a source of the sources of data;
identifying a second data processing system of the data processing systems nearest to a consumer of the consumers that provided the first goal;
identifying a third data processing system of the data processing systems nearest to a second consumer of the consumers that provided the second goal;
selecting the first data processing system for deployment of a shared input layer of the first inference model and the second inference model;
selecting the second data processing system for deployment of a first output layer of a first of the independent portions; and
selecting the third data processing system for deployment of a second output layer of a second of the independent portions.

18. The data processing system of claim 17, wherein providing the inferences comprises:
generating, using the shared input layer and the shared hidden layer, a partial processing result;
providing the partial processing result to both of the independent portions;
generating a first inference by the first of the independent portions, the first inference being responsive to the first goal; and
generating a second inference by the second of the independent portions, the second inference being responsive to the second goal; and.

19. The data processing system of claim 18, wherein obtaining the deployment plan comprises:
making an identification that an instance of the first inference model is hosted by the data processing systems;
based on the identification:
making a determination regarding whether an input layer of the instance of the first inference model and an output layer of the instance of the first inference model are within predetermined distances of locations specified by the first location data and the second location data; and
in an instance of the determination where the input layer of the instance of the first inference model and an output layer of the instance of the first inference model are within the predetermined distances:
establishing the instance of the first inference model as being part of the deployment plan; and
establishing a new instance of the second inference model that depends on operation of the instance of the first inference model.

20. The data processing system of claim 15, wherein obtaining the first location data comprises:
identifying latency of communication between each of the data processing systems and the sources of the data;
ranking the data processing systems based on the latency to obtain a ranking; and
obtaining the first location data based on the ranking.
